(19) United States
(12) Patent Application Publication
(10) Pub. No.: US 2009/0231253 A1
(43) Pub. Date: Sep. 17, 2009

(54) LCD WITH THE FUNCTION OF ELIMINATING THE POWER-OFF RESIDUAL IMAGES

(76) Inventor: Jen-Chieh Hu, Kaohsiung County (TW)

Correspondence Address: NORTH AMERICA INTELLECTUAL PROPERTY CORPORATION, P.O. BOX 506, MERRIFIELD, VA, 22116, US

(21) Appl. No.: 12/125,943

(22) Filed: May 23, 2008

(30) Foreign Application Priority Data
Mar. 11, 2008 (TW) 097108507

(51) Int. Cl. G09G 3/36

(52) U.S. Cl. 345/87; 345/211

(57) ABSTRACT

An LCD includes a display panel, a power supply, a source driver, and a gate driver. The source driver includes a hysteresis comparator and a level translator. The hysteresis comparator compares a supply voltage provided by the power supply with a reference voltage. The level translator is coupled to an output end of the hysteresis comparator for generating a control signal. The gate driver turns on a plurality of scan line of the display panel according to the control signal.

### BACKGROUND OF THE INVENTION

1. Field of the Invention

The present invention relates to an LCD, and more particularly, to an LCD with the function of eliminating the power-off residual images.

2. Description of the Prior Art

Currently the main reason causing the residual image on the LCD is that the pixel electrodes of the display panel discharge too slow when the power supply of the LCD is turned off. The electric charges cannot release immediately and remain in the liquid capacitors after the LCD is turned off so as to generate the residual image on the LCD, called power-off residual images.

Please refer to FIG. 1. FIG. 1 is a timing diagram of driving voltages of the LCD. A TFT LCD according to the prior art comprises a display panel and a backlight module. When the TFT LCD is turned on, a power supply of the TFT LCD is turned on at time t1 (waveform A), and voltages are applied to the common electrode and the pixel electrodes of the TFT LCD. Then, the image signals are inputted to the pixel array of the TFT LCD at time t2 (waveform B). Afterwards the backlight module is turned on at time t3 (waveform C) for providing the light to the display panel to display the image. When the LCD is turned off, operation is in reverse order, the backlight module is turned off at time t4, and the image signals end at time t5, and finally the power supply of the TFT LCD is turned off at time t6.

According to the above, during the period after the backlight is turned off and before the image signals end, that is, from time t4 to time t5, the image signals are still transmitted in the pixel array and the electric charges remain in the pixel electrodes, so it will take a long time to release the residual charges because of lack of effective discharge paths. Thus, the residual image is generated after time t6 when the TFT LCD is turned off.

Please refer to FIG. 2. FIG. 2 is a schematic diagram of an LCD with the function of eliminating the power-off residual images according to the prior art. The LCD 10 comprises a power supply 11, a voltage detector 12, a display panel 13, a gate driver 14, and a source driver 15. The power supply 11 provides a source voltage VCC to the source driver 15 and the gate driver 14. In addition, the power supply 11 provides the source voltage VCC to the voltage detector 12. The voltage detector 12 can compare the source voltage VCC with a reference voltage. When the LCD 10 is turned off, the source voltage VCC goes down to a level below the reference voltage. At this time, the voltage detector 12 sends a control signal XAO to the gate driver 14. When receiving the control signal XAO, the gate driver 14 turns on all thin film transistors so that the residual charges can be released effectively to improve the power-off residual images.

In conclusion, the LCD according to the prior art utilizes an external voltage detector to detect the level of the source voltage after time t6. When detecting the level of the source voltage being lower than the reference voltage, the voltage detector outputs a control signal to the gate driver to start the mechanism of eliminating the power-off residual images of the LCD. At this time, the gate driver turns on all thin film transistors of the display panel to release the residual charges to improve the power-off residual images.

### SUMMARY OF THE INVENTION

According to an embodiment of the present invention, an LCD with a function of eliminating power-off residual images comprises a display panel comprising a plurality of scan lines and a plurality of data lines, a power supply for outputting a supply voltage, a source driver, and a gate driver coupled to the plurality of scan lines. The source driver comprises a plurality of output channels coupled to the plurality of data lines, a hysteresis comparator, and a level translator coupled to an output end of the hysteresis comparator for generating a control signal. The gate driver turns on the plurality of scan lines according to the control signal.

According to another embodiment of the present invention, an LCD with a function of eliminating power-off residual images comprises a display panel comprising a plurality of scan lines and a plurality of data lines, a power supply for outputting a supply voltage, a gate driver coupled to the plurality of scan lines, and a source driver coupled to the plurality of data lines. The gate driver comprises a first detection circuit for comparing the supply voltage and a reference voltage to generate a first control signal. The gate driver turns on the plurality of scan lines according to the first control signal. The source driver comprises a second detection circuit for comparing the supply voltage and the reference voltage to generate a second control signal. The source driver outputs the same image signals to the plurality of data lines according to the second control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a timing diagram of driving voltages of an LCD according to the prior art.

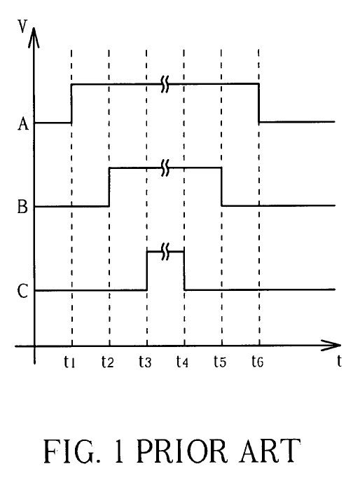

FIG. 2 is a schematic diagram of an LCD with the function of eliminating the power-off residual images according to the prior art.

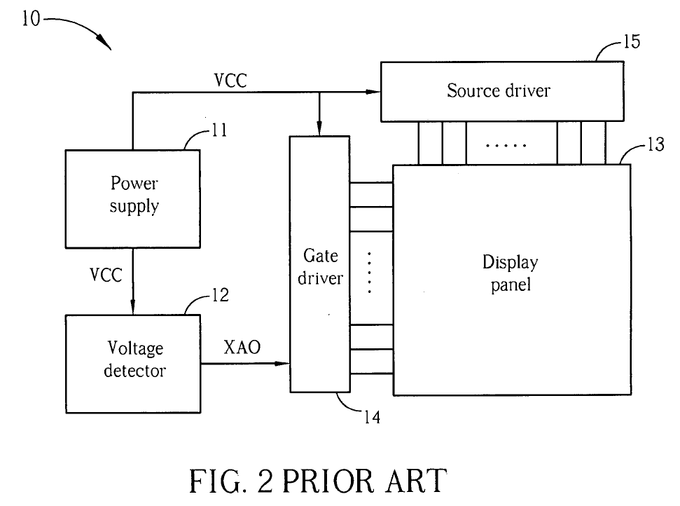

FIG. 3 is a schematic diagram of the first embodiment of an LCD according to the present invention.

FIG. 4 is a schematic diagram of the source driver in FIG. 3.

FIG. 5 is a waveform diagram of the signals of the source driver in FIG. 4.

FIG. 6 is a schematic diagram of the second embodiment of an LCD according to the present invention.

### DETAILED DESCRIPTION

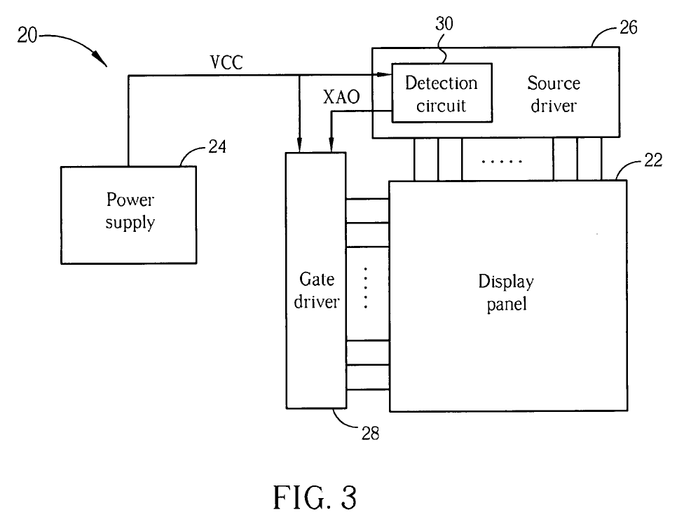

Please refer to FIG. 3. FIG. 3 is a schematic diagram of the first embodiment of an LCD according to the present invention. The LCD 20 comprises a display panel 22, a power supply 24, a source driver 26, and a gate driver 28. The power supply 24 provides a source voltage VCC to the source driver 26 and the gate driver 28. The display panel 22 comprises a plurality of scan lines and a plurality of data lines for controlling a plurality of thin film transistors. The LCD 20 has a function of eliminating the power-off residual images. The source driver 26 comprises a detection circuit 30 for detecting the source voltage VCC provided by the power supply 24, so that when the LCD 20 is turned off, the source driver 26 sends a control signal XAO to the gate driver 28. When receiving the control signal XAO, the gate driver 28 turns on the plurality of scan lines so as to turn on all thin film transistors of the display panel 22, which enables the release of the residual charges of the display panel 22. According to the embodiment of the present invention, the LCD 20 can utilize the source driver 26 to determine if the power-off of the LCD 20 is in action. After the power-off of the LCD 20 is confirmed, the source driver 26 outputs the control signal XAO to the gate driver 28. When receiving the control signal XAO, the gate driver 28 turns on all the thin film transistors of the display panel 22 to release the residual charges, and the power-off residual images of the LCD 20 will be removed.

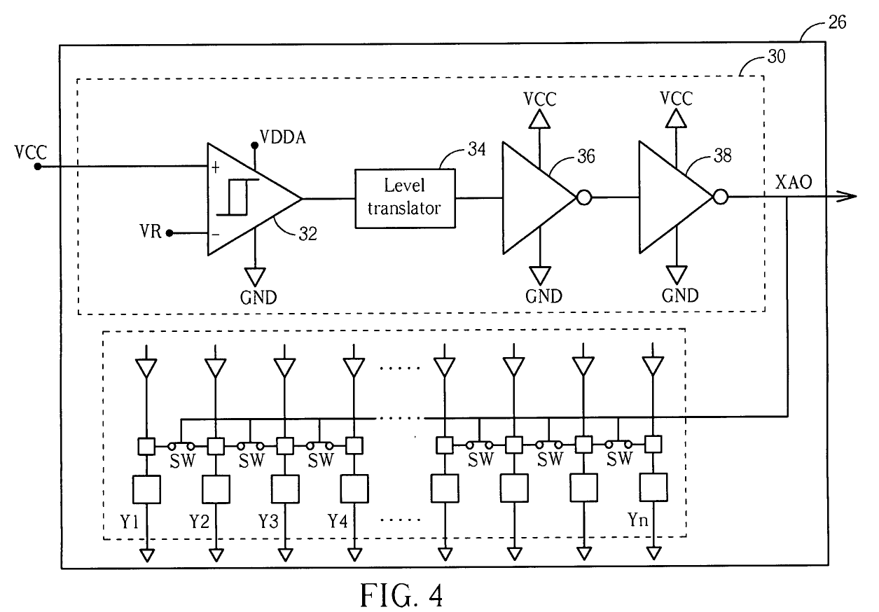

Please refer to FIG. 4. FIG. 4 is a schematic diagram of the source driver 26 in FIG. 3. The source driver 26 comprises a plurality of output channels (Y1˜Yn), a plurality of switches SW, a hysteresis comparator 32, a level translator 34, a first inverter 36, and a second inverter 38. A negative input end of the hysteresis comparator 32 receives a reference voltage VR, so the hysteresis comparator 32 can generate a first threshold voltage VTL and a second threshold voltage VTH according to the reference voltage VR. When the source voltage VCC is smaller than the first threshold voltage VTL, the hysteresis comparator 32 outputs a low level voltage. When the source voltage VCC is greater than the second threshold voltage VTH, the hysteresis comparator 32 outputs a high level voltage. The level translator 34 is coupled to an output end of the hysteresis comparator 32 for adjusting the level of the output voltage of the hysteresis comparator 32 so as to generate a control signal XAO. The first inverter 36 and the second inverter 38 are coupled in series to an output end of the level translator 34 for enhancing the driving capability of the control signal XAO. Each of the plurality of switches SW is coupled between two adjacent output channels (Y1˜Yn) respectively. The control signal XAO controls the plurality of switches SW to turn on or turn off. When the control signal XAO starts the function of eliminating the power-off residual images, the gate driver 28 turns on the plurality of scan lines of the display panel 22 so that the residual charges of the display panel 22 can be released. In addition, the plurality of switches SW of the source driver 26 is turned on to perform the charge sharing of the plurality of output channels (Y1˜Yn). Thus, even if the display panel 22 has the residual charges, it can hardly be noticed because of the uniform image of the display panel 22.

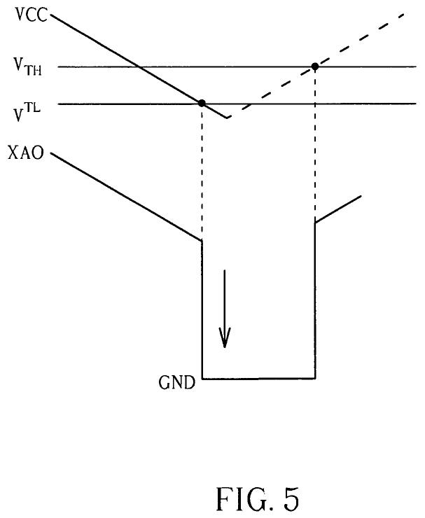

Please refer to FIG. 5. FIG. 5 is a waveform diagram of the signals of the source driver 26 in FIG. 4. When the source voltage VCC is smaller than the first threshold voltage VTL, the voltage level of the control signal XAO goes down to the ground voltage GND in a short time so as to start the function of eliminating the power-off residual images. However, after the function of eliminating the power-off residual images is started, the source voltage VCC may have a variation because the gate driver 28 turns on all scan lines of the display panel 22. Thus, a hysteresis function is added. The control signal XAO will not stop the function of eliminating the power-off residual images until the source voltage VCC is greater than the second threshold voltage VTH, thus the execution of the function of eliminating the power-off residual images can be assured while turning off the LCD 20.

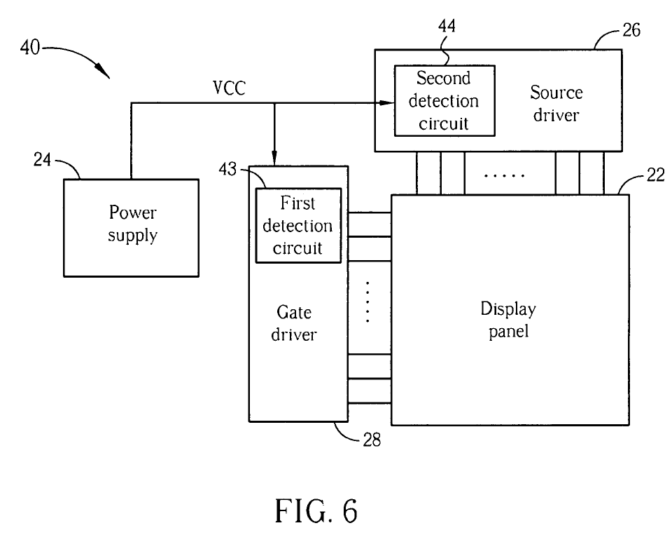

Please refer to FIG. 6. FIG. 6 is a schematic diagram of the second embodiment of an LCD according to the present invention. The LCD 40 comprises a power supply 24, a display panel 22, a gate driver 28, and a source driver 26. The display panel 22 comprises a plurality of scan lines and a plurality of data lines for controlling a plurality of thin film transistors. The gate driver 28 is coupled to the plurality of scan lines. The gate driver 28 comprises a first detection circuit 43 for comparing the source voltage VCC with a reference voltage to generate a first control signal. When the LCD 40 is turned off, the first detection circuit 43 can detect the source voltage VCC. When the source voltage VCC goes down to a level lower than the reference voltage, the gate driver 28 turns on the plurality of scan lines to turn on all thin film transistors of the display panel 22, so that the residual charges of the display panel 22 can be released. The source driver 26 is coupled to the plurality of data lines. The source driver 26 comprises a second detection circuit 44 for comparing the source voltage VCC with the reference voltage to generate a second control signal. Thus, the source driver 26 can detect the level of the source voltage VCC provided by the power supply 24, so that the accuracy of determining power-off of the LCD 40 can be increased. In addition, when the source voltage VCC goes down to a level lower than the reference voltage, the source driver 26 outputs the same image signals to the plurality of data lines. Thus, the residual charges of the LCD 40 can be released before the LCD 40 is powered off and the display panel 22 will display a uniform image. According to this embodiment, the LCD 40 utilizes the first detection circuit 43 of the gate driver 28 to determine the power-off. When the LCD 40 is turned off, the gate driver 28 turns on all scan lines. In addition, the LCD 40 utilizes the second detection circuit 44 of the source driver 26 to determine the power-off at the same time. When the LCD 40 is turned off, the source driver 26 outputs the same image signals to all data lines.

In conclusion, the LCD according to the present invention has the function of eliminating power-off residual images. The LCD comprises a display panel, a power supply, a source driver, and a gate driver. According to the embodiment of the present invention, the LCD can utilize the source driver to detect the power-off or utilize the source driver and the gate driver at the same time to detect the power-off. In the first embodiment, the source driver comprises a hysteresis comparator and a level translator. The hysteresis comparator compares a supply voltage provided by the power supply with a reference voltage. The level translator is coupled to an output end of the hysteresis comparator for generating a control signal. The gate driver turns on a plurality of scan line of the display panel according to the control signal. In the second embodiment, the gate driver comprises a first detection circuit for comparing a source voltage VCC with a reference voltage to generate a first control signal. The gate driver turns on all scan lines of the display panel according to the first control signal. In addition, the source driver comprises a second detection circuit for comparing the source voltage VCC with the reference voltage to generate a second control signal. The source driver outputs the same image signals to all data lines of the display panel. Thus, the LCD can release the residual charges in a short time and display a uniform image.

Those skilled in the art will readily observe that numerous modifications and alterations of the device and method may be made while retaining the teachings of the invention.

What is claimed is:

1. An LCD with a function of eliminating power-off residual images, the LCD comprising:
a display panel comprising a plurality of scan lines and a plurality of data lines;
a power supply for outputting a supply voltage;
a source driver, comprising:
a plurality of output channels coupled to the plurality of data lines;
a hysteresis comparator; and
a level translator coupled to an output end of the hysteresis comparator, for generating a control signal; and
a gate driver coupled to the plurality of scan lines, the gate driver turning on the plurality of scan lines according to the control signal.

2. The LCD of claim 1, wherein the source driver further comprises a first inverter and a second inverter coupled in series to an output end of the level translator.

3. The LCD of claim 1, wherein the source driver further comprises a plurality of switches coupled between each output channel respectively, the plurality of switches being turned on according to the control signal for performing the charge sharing between the plurality of output channels.

4. The LCD of claim 1, wherein a negative input end of the hysteresis comparator receives a reference voltage.

5. The LCD of claim 4, wherein the hysteresis comparator generates a first threshold voltage according to the reference voltage, and when the supply voltage is smaller than the first threshold voltage, the hysteresis comparator outputs a low level voltage.

6. The LCD of claim 4, wherein the hysteresis comparator generates a second threshold voltage according to the reference voltage, and when the supply voltage is greater than the second threshold voltage, the hysteresis comparator outputs a high level voltage.

7. An LCD with a function of eliminating power-off residual images, the LCD comprising:
a display panel comprising a plurality of scan lines and a plurality of data lines;
a power supply for outputting a supply voltage;
a gate driver coupled to the plurality of scan lines, comprising a first detection circuit for comparing the supply voltage and a reference voltage to generate a first control signal, the gate driver turning on the plurality of scan lines according to the first control signal; and
a source driver coupled to the plurality of data lines, comprising a second detection circuit for comparing the supply voltage and the reference voltage to generate a second control signal, the source driver outputting the same image signals to the plurality of data lines according to the second control signal.

8. The LCD of claim 7, wherein the source driver further comprises a plurality of switches each coupled between two adjacent output channels of the source driver, the plurality of switches being turned on according to the second control signal.

9. The LCD of claim 7, wherein the second detection circuit utilize a hysteresis comparator to compare the supply voltage and the reference voltage.
